(19) United States
(12) Patent Application Publication
(10) Pub. No.: US 2013/0251987 A1
(43) Pub. Date: Sep. 26, 2013

(54) POLYMER MEMBER HAVING RESISTANCE TO CIGARETTE BURNS, ARTICLE WITH RESISTANCE TO CIGARETTE BURNS, AND METHOD FOR PROVIDING RESISTANCE TO CIGARETTE BURNS

(71) Applicants: Yusuke Sugino, Ibaraki-shi (JP); Kunio Nagasaki, Ibaraki-shi (JP); Kohei Doi, Ibaraki-shi (JP); Takafumi Hida, Ibaraki-shi (JP); Yusuke Nakayama, Ibaraki-shi (JP)

(72) Inventors: Yusuke Sugino, Ibaraki-shi (JP); Kunio Nagasaki, Ibaraki-shi (JP); Kohei Doi, Ibaraki-shi (JP); Takafumi Hida, Ibaraki-shi (JP); Yusuke Nakayama, Ibaraki-shi (JP)

(73) Assignee: NITTO DENKO CORPORATION, Osaka (JP)

(21) Appl. No.: 13/990,162

(22) PCT Filed: Dec. 2, 2011
(86) PCT No.: PCT/JP2011/077942

§ 371 Date: May 29, 2013

(30) Foreign Application Priority Data
Dec. 7, 2010 (JP) 2010-272273
Dec. 20, 2010 (JP) 2010-282969
Dec. 20, 2010 (JP) 2010-282970
Apr. 26, 2011 (JP) 2011-097862

(51) Int. Cl. C09J 7/02

(52) U.S. Cl. CPC C09J 7/0264
USPC 428/343; 524/786; 428/688; 428/426

(57) ABSTRACT

Provided is a member which is excellent in transparency and flexibility, and can impart a resistance to cigarette burns to various adherends by being attached to the various adherends. Specifically provided is a polymer member with a resistance to cigarette burns, including a polymer layer, in which: the polymer layer contains a layered inorganic compound (f) in a polymer (X); and the polymer (X) contains a cross-linked polymer.

### TECHNICAL FIELD

The present invention relates to a polymer member with resistance to cigarette burns. The polymer member of the present invention is excellent in transparency and flexibility, and can impart the resistance to cigarette burns to various adherends by being attached to the various adherends. There can also be provided an article having resistance to cigarette burns imparted by attaching the polymer member to any of various adherends.

### BACKGROUND ART

There exist, at the surrounding, a large number of members each may cause a trouble of getting a singe or a hole on its surface through the approach or contact of a burning cigarette end. In order to prevent such trouble, impartation of the resistance to cigarette burns to such members has been performed.

As a member with a resistance to cigarette burns, there have been reported, for example, a cross-linked vinyl chloride sheet obtained by cross-linking a cross-linkable vinyl chloride resin (Patent Literature 1), and a decorative board having a metal intermediate layer (Patent Literatures 2 to 4).

However, the conventional member with a resistance to cigarette burns has the following problems. First, the conventional member with a resistance to cigarette burns has a problem in that the member has not been able to secure sufficient flexibility, resulting in a limited range of use. In addition, the conventional member with a resistance to cigarette burns has a problem in that the member is poor in transparency, and hence cannot express a design. Further, the conventional member with a resistance to cigarette burns has a problem in that the member often includes various layers in combination, and hence its production method is complicated. In addition, the conventional member with a resistance to cigarette burns may not be sufficient in strength, and may not have sufficient flame retardancy. Further, when peelability after immersion in water can be imparted to the member with a resistance to cigarette burns, the member can be applied to diverse situations of use.

### CITATION LIST

### Patent Literature

[PTL 1] JP 2009-114324 A
[PTL 2] JP 2007-030405 A
[PTL 3] JP 2006-315221 A
[PTL 4] JP 2006-142496 A

### SUMMARY OF INVENTION

### Technical Problem

An object of the present invention is to provide a member which is excellent in transparency and flexibility, and can impart the resistance to cigarette burns to various adherends by being attached to the various adherends. The object is preferably to provide a member further having high strength, to provide a member further having a high degree of flame retardancy, and to provide a member further having peelability after immersion in water.

An other object of the present invention is to provide a cigarette-resistant article having the member attached to any of various adherends. Still another object is to provide a method of providing a resistance to cigarette burns to an adherend involving attaching the member to any of various adherends.

### Solution to Problem

The inventors of the present invention have made extensive studies to solve the problems, and as a result, have found that the problems can be solved with the following member. Thus, the inventors have completed the present invention.

A polymer member of the present invention is a polymer member with a resistance to cigarette burns, including a polymer layer, in which: the polymer layer contains a layered inorganic compound (f) in a polymer (X); and the polymer (X) contains a cross-linked polymer.

In a preferred embodiment, the cross-linked polymer is obtained by polymerizing a polymerizable monomer containing a polyfunctional monomer.

In a preferred embodiment, the content ratio of the polyfunctional monomer in the polymerizable monomer is 5 to 100 wt %.

In a preferred embodiment, the polymer member of the present invention includes the polymer layer on at least one surface of a base material layer; and the polymer member has a tensile strength at 23° C. and a rate of pulling of 50 mm/min of 25 N/mm² or more.

In a preferred embodiment, the base material layer contains at least one kind selected from an inorganic material, an organic material, and a composite of an inorganic material and an organic material.

In a preferred embodiment, the polymer member of the present invention includes the polymer layer on at least one surface of an inorganic base material.

In a preferred embodiment, the inorganic base material includes a fibrous inorganic base material.

In a preferred embodiment, the fibrous inorganic base material includes a glass cloth.

In a preferred embodiment, the polymer member of the present invention includes the polymer layer and a pressure-sensitive adhesion layer; and the polymer (X) contains the cross-linked polymer and a hydrophilic polymer.

In a preferred embodiment, when the pressure-sensitive adhesion layer is attached to glass, left to stand still at room temperature for 24 hours, then immersed in water, and subjected to a peel test in a direction of 90°, 50 mm or more of the pressure-sensitive adhesion layer are peeled from the glass without breakage thereof.

In a preferred embodiment, a time period for the immersion in water is 3 minutes or more.

In another embodiment of the present invention, there is provided a cigarette-resistant article. The cigarette-resistant article of the present invention has the polymer member of the present invention attached to an adherend.

In still another embodiment of the present invention, there is provided a method of providing a resistance to cigarette burns to an adherend. The method of providing a resistance to cigarette burns to an adherend of the present invention involves attaching the polymer member of the present invention to an adherend, thereby providing the resistance to cigarette burns to the adherend.

### ADVANTAGEOUS EFFECTS OF INVENTION

The polymer member of the present invention has the polymer (X). Hence, the polymer member of the present invention can favorably maintain its flexibility, and has so wide a scope of applications as to be applicable to various applications.

There is no need to incorporate any halogen-based resin into the polymer member of the present invention.

The polymer member of the present invention can express excellent resistance to cigarette burns by virtue of the fact that the polymer (X) contains a cross-linked polymer. In particular, when a polymerizable monomer for constructing the cross-linked polymer contains 5 to 100 wt % of a polyfunctional monomer, the member can express additionally excellent resistance to cigarette burns.

The polymer member of the present invention is excellent in transparency because the ratio of the layered inorganic compound (f) in the polymer (X) can be controlled to be relatively small. In particular, even when the content ratio of ash in the polymer member of the present invention is as small a content ratio as less than 70 wt %, the member can exert the resistance to cigarette burns. The polymer member of the present invention is extremely excellent in transparency, and hence the resistance to cigarette burns can be provided to an adherend while the design of the adherend is secured.

The polymer member of the present invention is environmentally advantageous because there is no need to remove a volatile component (e.g., an organic solvent or an organic compound) in the polymerizable composition (α) through evaporation upon its production and hence a load on an environment can be reduced.

When the polymer member of the present invention includes a base material layer, the member can express high mechanical strength.

When the polymer member of the present invention includes an inorganic base material, the member can express a high degree of flame retardancy. In particular, when the inorganic base material is a fibrous inorganic base material, the member can express an additionally high degree of flame retardancy, and when the fibrous inorganic base material is a glass cloth, the member can express an extremely high degree of flame retardancy.

When the polymer (X) contains a hydrophilic polymer and the polymer member of the present invention includes a pressure-sensitive adhesion layer, the member has peelability after immersion in water, and can be applied to diverse situations of use.

### BRIEF DESCRIPTION OF DRAWINGS

FIG. 1 An example of a schematic sectional view of a polymer member of the present invention.

FIG. 2 An example of the schematic sectional view of the polymer member of the present invention.

FIG. 3 An example of the schematic sectional view of the polymer member of the present invention.

FIG. 4 An example of the schematic sectional view of the polymer member of the present invention.

FIG. 5 An example of the schematic sectional view of the polymer member of the present invention.

FIG. 6 An example of the schematic sectional view of the polymer member of the present invention.

### DESCRIPTION OF EMBODIMENTS

### 1. Polymer Member with Resistance to Cigarette Burns

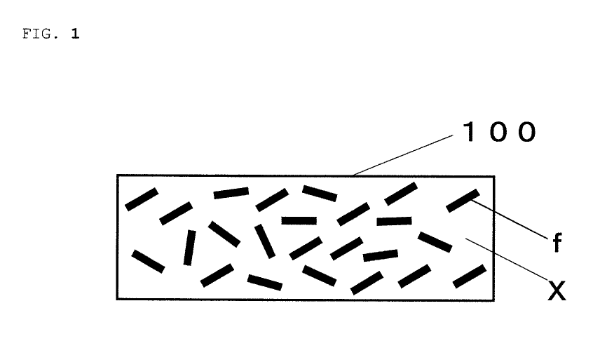

A polymer member of the present invention is a polymer member with a resistance to cigarette burns, including a polymer layer, in which the polymer layer contains a layered inorganic compound (f) in a polymer (X). The polymer (X) contains a cross-linked polymer. FIG. 1 illustrates a schematic sectional view of the polymer member of the present invention.

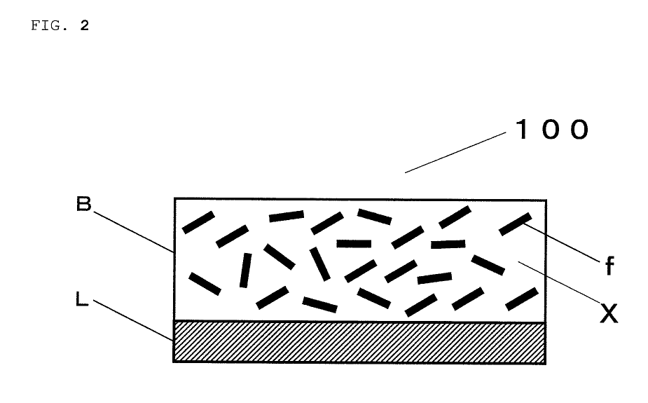

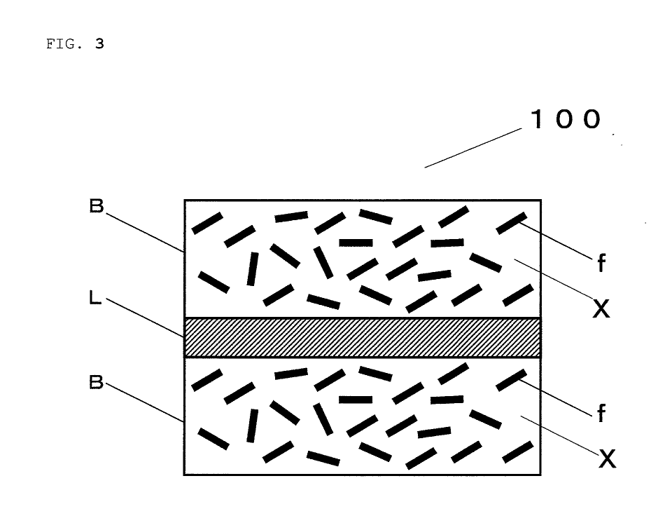

The polymer member of the present invention may be a polymer member with a resistance to cigarette burns, including the polymer layer on at least one surface of a base material layer. That is, the polymer member of the present invention may be one including the polymer layer on one surface of the base material layer, or may be one including the polymer layer on each of both surfaces of the base material layer. The polymer layer contains the layered inorganic compound (f) in the polymer (X), and the polymer (X) contains the cross-linked polymer. FIG. 2 and FIG. 3 each illustrate a schematic sectional view of such polymer member of the present invention. FIG. 2 illustrates the case where the polymer layer is present on one surface of the base material layer, and FIG. 3 illustrates the case where the polymer layer is present on each of both surfaces of the base material layer.

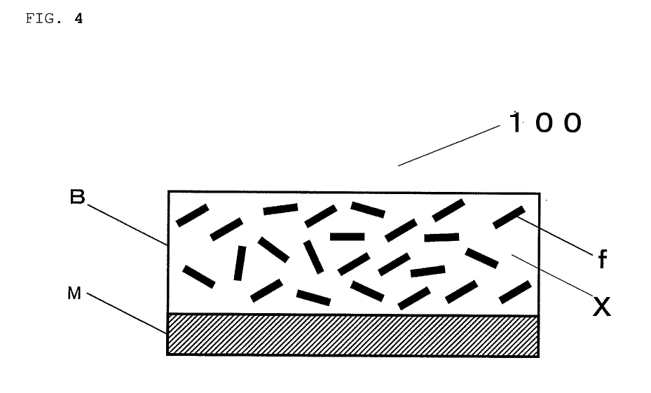

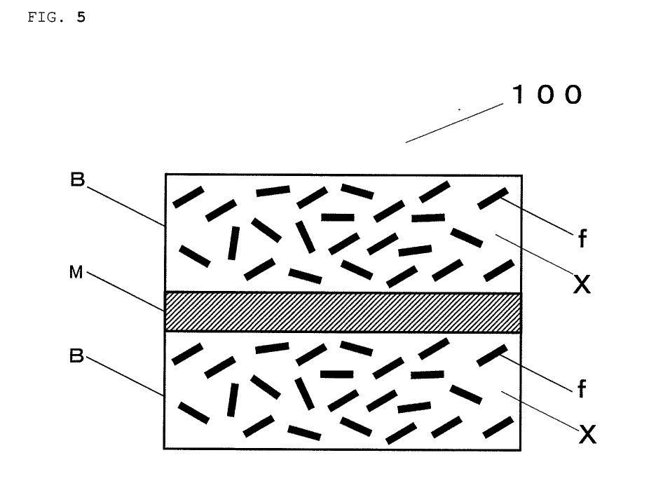

The polymer member of the present invention may be a polymer member with a resistance to cigarette burns, including the polymer layer on at least one surface of an inorganic base material. That is, the polymer member of the present invention may be one including the polymer layer on one surface of the inorganic base material, or may be one including the polymer layer on each of both surfaces of the inorganic base material. The polymer layer contains the layered inorganic compound (f) in the polymer (X), and the polymer (X) contains the cross-linked polymer. FIG. 4 and FIG. 5 each illustrate a schematic sectional view of such polymer member of the present invention. FIG. 4 illustrates the case where the polymer layer is present on one surface of the inorganic base material, and FIG. 5 illustrates the case where the polymer layer is present on each of both surfaces of the inorganic base material. It should be noted that a void portion of the inorganic base material may contain any appropriate component such as a constituent for the polymer layer or a formation material component for the polymer layer.

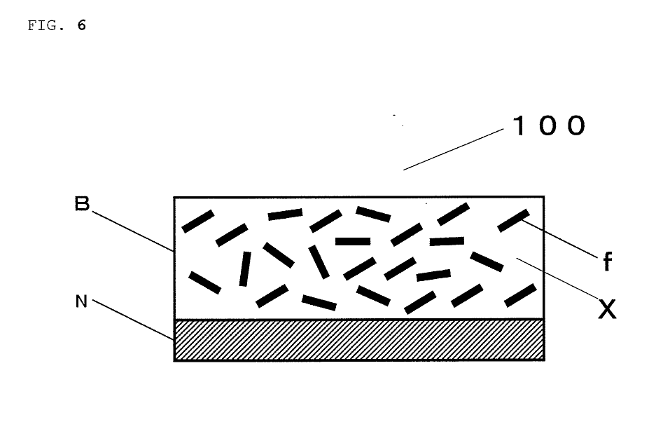

The polymer member of the present invention may be a polymer member with a resistance to cigarette burns, including the polymer layer and a pressure-sensitive adhesion layer. The polymer layer contains the layered inorganic compound (f) in the polymer (X). The polymer (X) contains the cross-linked polymer and a hydrophilic polymer. FIG. 6 illustrates a schematic sectional view of such polymer member of the present invention.

<<1-1. Polymer Layer>>

The polymer layer contains the layered inorganic compound (f) in the polymer (X), and the polymer (X) contains the cross-linked polymer. When the total thickness of the polymer layer is excessively small, sufficient resistance to cigarette burns may not be exhibited, and when the thickness is excessively large, the layer is hard to wind in a sheet shape and is hence poor in handleability in some cases. From these viewpoints, the thickness is preferably 10 to 1,000 μm, more preferably 15 to 800 μm, still more preferably 20 to 600 μm.

<1-1-1. Polymer (X)>

The polymer (X) is a polymer component constituting the polymer layer, and may be one kind of polymer or may be two or more kinds of polymers. In addition, the polymer (X) may contain any appropriate additive as long as the effect of the present invention is not impaired.

The content ratio of the cross-linked polymer in the polymer (X) is preferably 50 to 100 wt %, more preferably 70 to 100 wt %, still more preferably 90 to 100 wt %, particularly preferably 95 to 100 wt %, most preferably substantially 100 wt %. When the content ratio of the cross-linked polymer in the polymer (X) falls within the range, the polymer member of the present invention can express excellent resistance to cigarette burns.

The cross-linked polymer in the polymer (X) is preferably obtained by polymerizing a polymerizable monomer containing a polyfunctional monomer. The content ratio of the polyfunctional monomer in the polymerizable monomer that can be used for obtaining the cross-linked polymer is preferably 5 to 100 wt %, more preferably 10 to 100 wt %, still more preferably 15 to 100 wt %, particularly preferably 20 to 100 wt %, most preferably 25 to 100 wt %. When the content ratio of the polyfunctional monomer in the polymerizable monomer that can be used for obtaining the cross-linked polymer falls within the range, the polymer member of the present invention can express additionally excellent resistance to cigarette burns.

The polymerizable monomers (including polyfunctional monomers) that can be used for obtaining the cross-linked polymer in the polymer (X) may be used alone or in combination. In addition, the polyfunctional monomers that can be used for obtaining the cross-linked polymer in the polymer (X) may be used alone or in combination.

Examples of the polyfunctional monomer include 1,9-nonanediol di(meth)acrylate, 1,6-hexanediol di(meth)acrylate, 1,4-butanediol di(meth)acrylate, (poly)ethylene glycol di(meth)acrylate, (poly)propylene glycol di(meth)acrylate, neopentylglycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, and urethane acrylate. Of those, an acrylate-based polyfunctional monomer is preferred, and 1,9-nonanediol di(meth)acrylate, 1,6-hexanediol di(meth)acrylate, and 1,4-butanediol di(meth)acrylate are more preferred in terms of having high reactivity and possibly expressing excellent resistance to cigarette burns.

The polymerizable monomer that can be used for obtaining the cross-linked polymer in the polymer (X) may contain a monofunctional monomer in addition to the polyfunctional monomer. The term “monofunctional monomer” as used herein refers to a polymerizable monomer having only one polymerizable group. The monofunctional monomers may be used alone or in combination.

Any appropriate monofunctional monomer can be adopted as the monofunctional monomer. The monofunctional monomer is preferably an acrylic monomer. A preferred example of the acrylic monomer is an alkyl(meth)acrylate having an alkyl group. The alkyl (meth)acrylates each having an alkyl group may be used alone or in combination. It should be noted that the term “(meth) acryl” refers to “acryl” and/or “methacryl.”

Examples of the alkyl(meth)acrylate having an alkyl group include an alkyl(meth)acrylate having a linear or branched alkyl group, and an alkyl(meth)acrylate having a cyclic alkyl group. It should be noted that the alkyl(meth)acrylate as used herein means a monofunctional alkyl(meth)acrylte.

Examples of the alkyl(meth)acrylate having a linear or branched alkyl group include alkyl(meth)acrylates each having an alkyl group having 1 to 20 carbon atoms such as methyl (meth)acrylate, ethyl meth(acrylate), propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. Of those, an alkyl(meth)acrylate having an alkyl group having 2 to 14 carbon atoms is preferred, and an alkyl (meth)acrylate having an alkyl group having 2 to 10 carbon atoms is more preferred.

Examples of the alkyl(meth)acrylate having a cyclic alkyl group include cyclopentyl(meth)acrylate, cyclohexyl(meth)acrylate, and isobornyl(meth)acrylate.

The polymerizable monomer that can be used for obtaining the cross-linked polymer in the polymer (X) may contain a polar group-containing monomer and any other copolymerizable monomer in addition to the polyfunctional monomer and the monofunctional monomer. The incorporation of those monomers can improve the cohesive strength of the polymer (X), or can improve the adhesive strength of the polymer member of the present invention for an adherend. The polar group-containing monomers may be used alone or in combination. The other copolymerizable monomers may be used alone or in combination.

Examples of the polar group-containing monomer include: carboxyl group-containing monomers such as (meth)acrylic acid, itaconic acid, maleic acid, fumaric acid, crotonic acid, and isocrotonic acid, or anhydrides thereof (for example, maleic anhydride); hydroxy group-containing monomers such as a hydroxyalkyl (meth)acrylate such as hydroxyethyl (meth)acrylate, hydroxypropyl (meth)acrylate, or hydroxybutyl (meth)acrylate, vinyl alcohol, and allyl alcohol; amide group-containing monomers such as (meth)acrylamide, N,N-dimethyl (meth)acrylamide, N-methylol (meth) acrylamide, N-methoxymethyl (meth) acrylamide, and N-butoxymethyl (meth)acrylamide; amino group-containing monomers such as aminoethyl (meth)acrylate, dimethylaminoethyl (meth)acrylate, and t-butylaminoethyl (meth)acrylate; glycidyl group-containing monomers such as glycidyl (meth)acrylate and methylglycidyl (meth)acrylate; cyano group-containing monomers such as acrylonitrile and methacrylonitrile; heterocycle-containing vinyl-based monomers such as N-vinyl-2-pyrrolidone and (meth)acryloyl morpholine, as well as N-vinylpyridine, N-vinylpiperidone, N-vinylpyrimidine, N-vinylpiperazine, N-vinylpyrrole, N-vinylimidazole, and N-vinyloxazole; alkoxyalkyl(meth)acrylate-based monomers such as methoxyethyl (meth)acrylate and ethoxyethyl (meth)acrylate; sulfonate group-containing monomers such as sodium vinyl sulfonate; phosphate group-containing monomers such as 2-hydroxyethyl acryloyl phosphate; imide group-containing monomers such as cyclohexyl maleimide and isopropyl maleimide; and isocyanate group-containing monomers such as 2-methacryloyloxyethyl isocyanate. The polar group-containing monomer is preferably a carboxyl group-containing monomer or an anhydride thereof, more preferably acrylic acid.

Examples of the other copolymerizable monomer include: alkyl(meth)acrylates such as a (meth)acrylate having an aromatic hydrocarbon group such as phenyl (meth)acrylate; vinyl esters such as vinyl acetate and vinyl propionate; aromatic vinyl compounds such as styrene and vinyl toluene; olefins or dienes such as ethylene, butadiene, isoprene, and isobutylene; vinyl ethers such as a vinyl alkyl ether; vinyl chloride; alkoxyalkyl(meth)acrylate-based monomers such as methoxyethyl (meth)acrylate and ethoxyethyl (meth)acrylate; sulfonate group-containing monomers such as sodium vinyl sulfonate; phosphate group-containing monomers such as 2-hydroxyethyl acryloyl phosphate; imide group-containing monomers such as cyclohexylmaleimide and isopropylmaleimide; isocyanate group-containing monomers such as 2-methacryloyloxyethyl isocyanate; fluorine atom-containing (meth)acrylates; and silicon atom-containing (meth)acrylates.

Pressure-sensitive adhesive property can be imparted to the polymer (X) through the selection of a polymer material for forming the polymer. For example, an acrylic resin, an epoxy resin, an oxetane-based resin, a vinyl ether-based resin, a urethane-based resin, and a polyester-based resin function as a base polymer for an acrylic pressure-sensitive adhesive, a base polymer for an epoxy-based pressure-sensitive adhesive, a base polymer for an oxetane-based pressure-sensitive adhesive, a base polymer for a vinyl ether-based pressure-sensitive adhesive, a base polymer for a urethane-based pressure-sensitive adhesive, and a base polymer for a polyester-based pressure-sensitive adhesive, respectively.

An acrylic monomer can be preferably adopted as the polymerizable monomer to be used for producing the polymer (X). Accordingly, the polymer (X) is preferably an acrylic polymer.

<1-1-2. Layered Inorganic Compound (f)>

Examples of the layered inorganic compound (f) to be incorporated into the polymer (X) include a layered inorganic substance and an organically treated product thereof. The layered inorganic compound (f) may be a solid, or may have flowability. The layered inorganic compounds may be used alone or in combination.

An inorganic substance which can form the layered inorganic substance is exemplified by a silicate and a clay mineral. Of those, a layered clay mineral is preferred as the layered inorganic substance.

Examples of the layered clay mineral include: a smectite such as montmorillonite, beidellite, hectorite, saponite, nontronite, or stevensite; vermiculite; bentonite; and a layered sodium silicate such as kanemite, kenyaite, or makatite. Such layered clay mineral may be yielded as a natural mineral, or may be produced by a chemical synthesis method.

The organically treated product of the layered inorganic substance is a product obtained by treating the layered inorganic substance with an organic compound. An example of the organic compound is an organic cationic compound. Examples of the organic cationic compound include cationic surfactants each having a cationic group such as a quarternary ammonium salt or a quarternary phosphonium salt. The cationic surfactant has a cationic group such as a quaternary ammonium salt or a quaternary phosphonium salt on a propylene oxide skeleton, an ethylene oxide skeleton, an alkyl skeleton, or the like. Such cationic group forms a quaternary salt with, for example, a halide ion (e.g., a chloride ion).

Examples of the cationic surfactant which has a quaternary ammonium salt include a lauryltrimethylammonium salt, a stearyltrimethylammonium salt, a trioctylammonium salt, a distearyldimethylammonium salt, a distearyldibenzylammonium salt, and an ammonium salt having a methyldiethylpropylene oxide skeleton.

Examples of the cationic surfactant which has a quaternary phosphonium salt include a dodecyltriphenyl phosphonium salt, a methyltriphenyl phosphonium salt, a lauryltrimethyl phosphonium salt, a stearyltrimethyl phosphonium salt, a distearyldimethyl phosphonium salt, and a distearylbenzyl phosphonium salt.

The layered inorganic substance such as the layered clay mineral is treated with the organic cationic compound. As a result, a cation between layers undergoes ion exchange with a cationic group of a quaternary salt or the like. Examples of the cation of the clay mineral include metal cations such as a sodium ion and a calcium ion. The layered clay mineral treated with the organic cationic compound is easily swollen and dispersed in the polymer or the polymerizable monomer. Examples of the layered clay mineral treated with the organic cationic compound include LUCENTITE series (manufactured by Co-op Chemical Co., Ltd.). More specific examples thereof include LUCENTITE SPN, LUCENTITE SAN, LUCENTITE SEN, and LUCENTITE STN.

In addition, examples of the organically treated product of the layered inorganic substance include products obtained by subjecting the surface of the layered inorganic substance to surface treatments with various organic compounds (e.g., a surface tension-lowering treatment with a silicone-based compound or a fluorine-based compound).

The ratio of the organic compound to the layered inorganic substance in the organically treated product of the layered inorganic substance varies depending on the cation-exchange capacity (“CEC”) of the layered inorganic substance. The CEC relates to the ion-exchange capacity of the layered inorganic compound (f) or the total quantity of positive charge that can be caused to adsorb on the surface of the layered inorganic substance, and is represented by positive charge per unit mass of colloid particles, that is, “coulomb (s) per unit mass” in an SI unit. The CEC may be represented by milliequivalent(s) per gram (meq/g) or milliequivalent(s) per 100 grams (meq/100 g). A CEC of 1 meq/g corresponds to 96.5 C/g in the SI unit. Several CEC values concerning representative clay minerals are as described below. The CEC of montmorillonite falls within the range of 70 to 150 meq/100 g, the CEC of halloysite falls within the range of 40 to 50 meq/100 g, and the CEC of kaolin falls within the range of 1 to 10 meq/100 g.

The ratio of the organic compound to the layered inorganic substance in the organically treated product of the layered inorganic substance is such that the amount of the organic compound is preferably 1,000 parts by weight or less, more preferably 3 to 700 parts by weight, more preferably 5 to 500 parts by weight with respect to 100 parts by weight of the layered inorganic substance.

With regard to the particle diameter (average particle diameter) of the layered inorganic compound (f), its particles are preferably packed as densely as possible in the polymer (X) from the viewpoint of obtaining excellent resistance to cigarette burns. For example, the average of primary particle diameters when the layered inorganic compound (f) is dispersed in a dilute solution is preferably 5 nm to 10 μm, more preferably 6 nm to 5 μm, still more preferably 7 nm to 1 μm in terms of a median diameter in a laser scattering method or a dynamic light scattering method. It should be noted that a combination of two or more kinds of particles having different particle diameters may be used as the particles.

The shape of each of the particles of the layered inorganic compound (f) may be any shape, e.g., a spherical shape such as a true spherical shape or an ellipsoidal shape, an amorphous shape, a needle-like shape, a rod-like shape, a flat plate-like shape, a flaky shape, or a hollow tubular shape. The shape of each of the particles is preferably a flat plate-like shape or a flaky shape. In addition, the surface of each of the particles may have a pore, a protrusion, or the like.

In addition, the average of maximum primary particle diameters is preferably 5 μm or less, more preferably 5 nm to 5 μm because the transparency may be problematic as the particle diameter of the layered clay mineral increases.

It should be noted that the Lucentite SPN (manufactured by Co-op Chemical Co., Ltd.) is obtained by subjecting the layered clay mineral to organizing treatment with an organic compound having a quaternary ammonium salt, and the ratio of the organic compound is 62 wt %. With regard to its particle diameter, the Lucentite SPN has a 25% average primary particle diameter of 19 nm, a 50% average primary particle diameter of 30 nm, and a 99% average primary particle diameter of 100 nm. The Lucentite SPN has a thickness of 1 nm and an aspect ratio of about 30.

When particles are used as the layered inorganic compound (f), the layered inorganic compound (f) can contribute to, for example, the formation of surface unevenness by the particles in the surface of the polymer layer in some cases.

In addition, when the product obtained by treating the layered clay mineral with the organic cationic compound is used as the layered inorganic compound (f), the surface resistance value of the polymer member of the present invention can be preferably set to 1×10¹⁴ (Ω/□) or less, and hence antistatic property can be imparted to the polymer member of the present invention. The antistatic property can be controlled to desired antistatic property by controlling, for example, the kind, shape, size, and content of the layered inorganic compound (f), and the composition of the polymer component (polymer (X)) in the polymer member.

The layered inorganic compound (f) and the polymer component (polymer (X)) are mixed in the polymer layer, and hence the layer can exert a characteristic based on the polymer component, and at the same time, can exert a characteristic inherent in the layered inorganic compound (f). The content ratio of ash in the polymer layer (the content ratio of the layered inorganic compound (f) with respect to the total amount of the formation materials for the polymer layer, provided that when the layered inorganic compound (f) is an organically treated product of a layered inorganic substance, the content ratio of the layered inorganic substance that has not been subjected to any organic treatment) can be appropriately set depending on the kind of the layered inorganic compound (f). The content ratio is preferably 3 wt % or more and less than 70 wt %. When the content ratio is 70 wt % or more, the layered inorganic compound (f) may not be favorably dispersed. As a result, a lump is liable to be produced and hence it becomes difficult to produce the polymer layer in which the layered inorganic compound (f) has been uniformly dispersed in some cases. In addition, when the content ratio exceeds 70 wt %, the transparency and flexibility of the polymer layer may reduce. On the other hand, when the content ratio is less than 3 wt %, the polymer member of the present invention does not have a resistance to cigarette burns in some cases. The content ratio of ash in the polymer layer is preferably 3 to 60 wt %, more preferably 5 to 50 wt %.

<1-1-3. Additive>

Any appropriate additive may be incorporated into the polymer (X). Examples of such additive include a surfactant (e.g., an ionic surfactant, a silicone-based surfactant, or a fluorine-based surfactant), a cross-linking agent (e.g., a polyisocyanate-based cross-linking agent, a silicone-based cross-linking agent, an epoxy-based cross-linking agent, or an alkyl-etherified melamine-based cross-linking agent), a plasticizer, a filler, an age resister, an antioxidant, a colorant (e.g., a pigment or a dye), and a solvent (e.g., an organic solvent).

A pigment (coloring pigment) may be incorporated into the polymer (X) from the viewpoints of, for example, design and optical characteristics. When a black color is desired, carbon black can be used as the coloring pigment. The usage of the pigment (coloring pigment) is, for example, preferably 0.15 part by weight or less, more preferably 0.001 to 0.15 part by weight, still more preferably 0.02 to 0.1 part by weight with respect to 100 parts by weight of the polymer (X) from such a viewpoint that the degree of coloring is not inhibited.

<<1-2. Base Material Layer>>

A layer containing any appropriate material can be adopted as the base material layer as long as the layer can impart high mechanical strength to the polymer member of the present invention. Example's of such material include an inorganic material, an organic material, and a composite of an inorganic material and an organic material.

Examples of the inorganic material include an inorganic oxide, a metal, glass, plaster, concrete, mortar, a clay mineral, paper, and a non-woven fabric.

Examples of the organic material include lumber and a resin. The resin is, for example, a polyester resin.

Any appropriate shape can be adopted as the shape of the base material layer. Examples of the shape of the base material layer include a sheet shape (e.g., a plaster board or a resin layer), a foil shape (e.g., a metal foil), and a textile shape (e.g., a glass cloth or a non-woven fabric).

The thickness of the base material layer is preferably 1 to 5,000 μm, more preferably 2 to 4,000 μm, still more preferably 3 to 3,000 μm. When the thickness of the base material layer falls within the range, the polymer member of the present invention can express high mechanical strength.

<<1-3. Inorganic Base Material>>

Any appropriate inorganic base material can be adopted as the inorganic base material. Examples of such inorganic base material include inorganic base materials having voids such as a fibrous inorganic base material and a network inorganic base material. It should be noted that a void portion of the inorganic base material may contain any appropriate component such as a constituent for the polymer layer or a formation material component for the polymer layer.

The form of the fibrous inorganic base material is, for example, a woven fabric or a non-woven fabric.

Specific examples of the fibrous inorganic base material include a glass cloth, asbestos, a carbon fiber, and a fibrous metal oxide. The fibrous inorganic base material is preferably a glass cloth.

The network inorganic base material is specifically, for example, a metal mesh.

Any appropriate thickness can be adopted as the thickness of the inorganic base material depending on its kind. The thickness is, for example, preferably 1 to 500 μm.

When the polymer member of the present invention includes the inorganic base material, the member can express a high degree of flame retardancy. In particular, when the inorganic base material is a fibrous inorganic base material, the member can express an additionally high degree of flame retardancy, and when the fibrous inorganic base material is a glass cloth, the member can express an extremely high degree of flame retardancy.

<<1-4. Pressure-Sensitive Adhesion Layer>>

A layer containing any appropriate material can be adopted as the pressure-sensitive adhesion layer as long as the layer can impart satisfactory peelability after immersion in water to the polymer member of the present invention by forming a laminated structure with the polymer layer.

The pressure-sensitive adhesion layer is, for example, a pressure-sensitive adhesive layer formed of a polymer material capable of imparting pressure-sensitive adhesive property. Examples of such polymer material include an acrylic resin, an epoxy resin, an oxetane-based resin, a vinyl ether-based resin, a urethane-based resin, and a polyester-based resin. Those resins can function as, for example, a base polymer for an acrylic pressure-sensitive adhesive, a base polymer for an epoxy-based pressure-sensitive adhesive, a base polymer for an oxetane-based pressure-sensitive adhesive, a base polymer for a vinyl ether-based pressure-sensitive adhesive, a base polymer for a urethane-based pressure-sensitive adhesive, and a base polymer for a polyester-based pressure-sensitive adhesive, respectively.

The thickness of the pressure-sensitive adhesion layer is preferably 10 to 5,000 μm, more preferably 20 to 4,000 μm, still more preferably 30 to 3,000 μm. When the thickness of the pressure-sensitive adhesion layer falls within the range, the layer can impart satisfactory peelability after immersion in water to the polymer member of the present invention by forming a laminated structure with the polymer layer.

<<1-5. Polymer Member>>

The total thickness of the polymer member of the present invention is as described below because when the thickness is excessively small, the member may not show sufficient resistance to cigarette burns, and when the thickness is excessively large, the member is hard to wind in a sheet shape and is hence poor in handleability in some cases.

In such form as illustrated in FIG. 1 (in the case where the polymer member of the present invention is formed of substantially only the polymer layer), the total thickness of the polymer member of the present invention is preferably 10 to 1,000 μm, more preferably 15 to 800 μm, still more preferably 20 to 600 μm.

In each of such forms as, for example, illustrated in FIGS. 2 to 6 (in the case where the polymer member of the present invention includes any other layer or base material such as the base material layer, the inorganic base material, or the pressure-sensitive adhesion layer), the total thickness of the polymer member of the present invention is preferably 10 to 5,000 μm, more preferably 20 to 4,000 μm, still more preferably 30 to 3,000 μm.

<1-5-1. Resistance to Cigarette Burns>

The polymer member of the present invention preferably satisfies the following resistance to cigarette burns. That is, the polymer member of the present invention has a resistance to cigarette burns in a resistance to cigarette burns test involving: horizontally placing the polymer member with the polymer layer as an upper surface; laying a live cigarette on the upper surface of the polymer member for 30 seconds, or pressing a live cigarette against the upper surface for 5 seconds; removing the cigarette after the laying or pressing; and examining the upper surface for the presence or absence of a singe and a hole after the upper surface has been wiped. The member is more excellent in resistance to cigarette burns as the degree of singe in the resistance to cigarette burns test reduces. The member is more excellent in resistance to cigarette burns as the degree of perforation in the test reduces.

<1-5-2. Transparency>

The polymer member of the present invention is substantially transparent, and has a total light transmittance of preferably 60% or more, more preferably 70% or more, still more preferably 80% or more, particularly preferably 90% or more. Further, its haze is preferably 20% or less, more preferably 15% or less, still more preferably 10% or less, particularly preferably 5% or less.

<1-5-3. Flexibility>

The polymer member of the present invention has flexibility peculiar to plastic. For example, in the case where no flaw or crack occurs even when both ends of a side having a length of 5 cm of the polymer member measuring 5 cm by 10 cm are repeatedly brought into contact with each other 50 times by bending the side in a mountain fold manner and in a valley fold manner, the member can be judged to have good flexibility. In addition, in the case where no flaw or crack occurs in the polymer member measuring 5 cm by 10 cm when the polymer member measuring 5 cm by 10 cm is wound around a rod having a diameter of 1 cm and then the polymer member is peeled, the member can be judged to have good flexibility.

<1-5-4. Mechanical Strength>

The polymer member of the present invention can express high mechanical strength by virtue of the presence of the base material layer. The high strength polymer member of the present invention has a tensile strength at 23° C. and a rate of pulling of 50 mm/min of 25 N/mm² or more, preferably 30 N/mm² or more, more preferably 50N/mm² or more, still more preferably 70 N/mm² or more, particularly preferably 90 N/mm² or more, most preferably 100 N/mm² or more. An upper limit for the tensile strength is not particularly limited, but is preferably 10,000 N/mm² or less when handleability and the like are taken into consideration. A specific method of measuring the tensile strength is described later.

<1-5-5. Flame Retardancy>

The polymer member of the present invention has a high degree of flame retardancy. That is, the polymer member of the present invention has, for example, in a heat-generating property test involving measurement in conformity with a cone calorimeter method, preferably a small total quantity of heat to be generated and has no rupture due to heat when observed for the external appearance of the polymer member.

<1-5-6. Peelability>

The polymer member of the present invention has re-peelability based on the utilization of water. When the pressure-sensitive adhesion layer is attached to glass, left to stand still at room temperature for 24 hours, then immersed in water, and subjected to a peel test in a direction of 90°, 50 mm or more of the pressure-sensitive adhesion layer can be preferably peeled from the glass without breakage thereof. It is more preferred that a time period for the immersion in water be 3 minutes or more. When the peelability of the polymer member of the present invention is as described above, the polymer member of the present invention can be said to have satisfactory peelability after immersion in water. A specific method of evaluating the peelability is described later.

### 2. Production of Polymer Member

The polymer member of the present invention can be produced by any appropriate method. When the polymer member of the present invention includes the base material layer, the member can be preferably produced by a method involving applying a material for forming the polymer layer onto at least one surface of the base material layer to form a layer and then performing curing treatment as required. When the polymer member of the present invention includes the inorganic base material, the member can be preferably produced by, for example: (1) a method involving applying a material for forming the polymer layer onto at least one surface of the inorganic base material to form a layer and then performing curing treatment as required; or (2) a method involving placing the inorganic base material on a layer obtained by applying a material for forming the polymer layer onto an appropriate base material, further applying a material for forming the polymer layer onto the inorganic base material to form a layer as required, and then performing curing treatment as required. When the polymer member of the present invention includes the pressure-sensitive adhesion layer, the member can be preferably produced by performing polymerization by a method involving applying a material for forming the polymer layer onto one surface of the pressure-sensitive adhesion layer to form a layer and then performing curing treatment as required.

The polymer layer is preferably obtained by performing polymerization of a syrupy polymerizable composition layer (a) formed of a polymerizable composition (α) containing a polymerizable monomer (m), which contains a polyfunctional monomer, and the layered inorganic compound (f). The step of performing polymerization is referred to as polymerizing step.

That is, when the polymer member of the present invention includes the base material layer, as a preferred method of producing the polymer member of the present invention, there is given, for example, a method involving forming the syrupy polymerizable composition layer (a) from the polymerizable composition (α) containing the polymerizable monomer (m), which contains a polyfunctional monomer, and the layered inorganic compound (f) on at least one surface of the base material layer and performing the polymerization of the polymerizable composition layer (a).

In addition, when the polymer member of the present invention includes the inorganic base material, as a preferred method of producing the polymer member of the present invention, there is given, for example: (1) a method involving forming the syrupy polymerizable composition layer (a) from the polymerizable composition (α) containing the polymerizable monomer (m), which contains a polyfunctional monomer, and the layered inorganic compound (f) on at least one surface of the inorganic base material and performing the polymerization of the polymerizable composition layer (a); and (2) a method involving placing the inorganic base material on the syrupy polymerizable composition layer (a) obtained by applying the polymerizable composition (α) containing the polymerizable monomer (m), which contains a polyfunctional monomer, and the layered inorganic compound (f) onto an appropriate base material, further applying the polymerizable composition (α) containing the polymerizable monomer (m), which contains a polyfunctional monomer, and the layered inorganic compound (f) onto the inorganic base material to form the syrupy polymerizable composition layer (a) as required, and then performing curing treatment as required.

In addition, when the polymer member of the present invention includes the pressure-sensitive adhesion layer, as a preferred method of producing the polymer member of the present invention, there is given, for example, a method involving forming the syrupy polymerizable composition layer (a) formed from the polymerizable composition (α) containing the polymerizable monomer (m), which contains a polyfunctional monomer and a hydrophilic monomer, and the layered inorganic compound (f) on a pressure-sensitive adhesive base material and then performing polymerization.

<2-1. Polymerizable Composition (α)>

The polymerizable composition (α) contains at least the polymerizable monomer (m) capable of being polymerized and the layered inorganic compound (f). The polymerizable composition (α) can contain a polymerization initiator as appropriate. When the polymerizable monomer (m) is subjected to photocuring, the polymerizable composition (α) can contain a photopolymerization initiator as the polymerization initiator.

The polymerizable composition (α) may be a partially polymerized composition obtained by polymerizing part of the polymerizable monomer (m) in terms of, for example, handleability and application property.

The description of the polymerizable monomer in the section <1-1-1. Polymer (X)> can be cited as a specific description of the polymerizable monomer (m).

The description in the section <1-1-2. Layered inorganic compound (f)> can be cited as a specific description of the layered inorganic compound (f).

The polymerizable composition (α) may contain any appropriate additive. The description in the section <1-1-3. Additive> can be cited as a specific description of such additive.

The polymerization initiator can be used as required. Examples of the polymerization initiator include a photopolymerization initiator and a thermal polymerization initiator. The polymerization initiators may be used alone or in combination.

Any appropriate photopolymerization initiator can be adopted as the photopolymerization initiator. As the photopolymerization initiator, there can be used, for example, a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzyl-based photopolymerization initiator, a benzophenone-based photopolymerization initiator, a ketal-based photopolymerization initiator, a thioxanthone-based photopolymerization initiator, and an acylphosphine oxide-based photopolymerization initiator. The photopolymerization initiators may be used alone or in combination.

Examples of the benzoin ether-based photopolymerization initiator include benzoin methyl ether, benzoin ethyl ether, benzoin propyl ether, benzoin isopropyl ether, and benzoin isobutyl ether. Examples of the acetophenone-based photopolymerization initiator include 1-hydroxycyclohexyl phenyl ketone (e.g., “IRGACURE 184” (trade name; manufactured by Ciba Specialty Chemicals Inc.)), 2,2-diethoxyacetophenone, 2,2-dimethoxy-2-phenylacetophenone, 4-phenoxydichloroacetophenone, and 4-(t-butyl)dichloroacetophenone. Examples of the α-ketol-based photopolymerization initiator include 2-methyl-2-hydroxypropiophenone and 1-[4-(2-hydroxyethyl)phenyl]-2-methylpropan-1-one. An example of the aromatic sulfonyl chloride-based photopolymerization initiator is 2-naphthalenesulfonyl chloride. An example of the photoactive oxime-based photopolymerization initiator is 1-phenyl-1,1-propanedione-2-(o-ethoxycarbonyl)-oxime. An example of the benzoin-based photopolymerization initiator is benzoin. An example of the benzyl-based photopolymerization initiator is benzil. Examples of the benzophenone-based photopolymerization initiator include benzophenone, benzoylbenzoic acid, 3,3′-dimethyl-4-methoxybenzophenone, polyvinyl benzophenone, and α-hydroxycyclohexyl phenyl ketone. An example of the ketal-based photopolymerization initiator is 2,2-dimethoxy-1,2-diphenylethan-1-one (e.g., “IRGACURE 651” (trade name; manufactured by Ciba Specialty Chemicals Inc.)). Examples of the thioxanthone-based photopolymerization initiator include thioxanthone, 2-chlorothioxanthone, 2-methylthioxanthone, 2,4-dimethylthioxanthone, isopropylthioxanthone, 2,4-diisopropylthioxanthone, and dodecylthioxanthone. An example of the acylphosphine oxide-based photopolymerization initiator is “Lucirin TPO” (trade name; manufactured by BASF Japan Ltd.).

The usage of the photopolymerization initiator is, for example, preferably 5 parts by weight or less, more preferably 0.01 to 5 parts by weight, still more preferably 0.05 to 3 parts by weight with respect to 100 parts by weight of the polymerizable monomer (m) in the polymerizable composition (α).

Any appropriate thermal polymerization initiator can be adopted as the thermal polymerization initiator. Examples of the thermal polymerization initiator include an azo-based polymerization initiator (e.g., 2,2′-azobisisobutyronitrile, 2,2′-azobis-2-methylbutyronitrile, dimethyl 2,2′-azobis(2-methylpropionate), 4,4′-azobis-4-cyanovaleric acid, azobisisovaleronitrile, 2,2′-azobis(2-amidinopropane) dihydrochloride, 2,2′-azobis[2-(5-methyl-2-imidazolin-2-yl)propane]dihydrochloride, 2,2′-azobis(2-methylpropionamidine) disulfate, or 2,2′-azobis(N,N′-dimethyleneisobutylamidine) dihydrochloride), a peroxide-based polymerization initiator (e.g., dibenzoyl peroxide or tert-butyl permaleate), and a redox-based polymerization initiator (e.g., a combination of: an organic peroxide and a vanadium compound; an organic peroxide and dimethylaniline; or a metal naphthenate and butylaldehyde, aniline, or acetylbutyrolactone).

The usage of the thermal polymerization initiator is, for example, preferably 5 parts by weight or less, more preferably 0.01 to 5 parts by weight, still more preferably 0.05 to 3 parts by weight with respect to 100 parts by weight of the polymerizable monomer (m) in the polymerizable composition (α).

The use of the redox-based polymerization initiator as the thermal polymerization initiator enables polymerization at normal temperature.

Whether or not a substance is a substance incompatible with a polymer can be judged by means of visual observation, an optical microscope, a scanning electron microscope (SEM), a transmission electron microscope (TEM), X-ray diffraction, or the like on the basis of the size of the substance or an aggregate thereof dispersed in the polymer in a general method (e.g.: a method involving dissolving the substance in a polymerizable monomer, polymerizing the polymerizable monomer to provide a polymer, and performing the judgment; a method involving dissolving the polymer in a solvent that dissolves the polymer, adding the substance to the solution, stirring the mixture, removing the solvent after the stirring, and performing the judgment; or a method involving heating the polymer, when the polymer is a thermoplastic polymer, to dissolve the polymer, compounding the substance into the dissolved polymer, cooling the mixture, and performing the judgment after the cooling). Criteria for the judgment are as described below. When the substance or the aggregate thereof can be approximated as a spherical shape such as a sphere, a cube, or an amorphous shape, the substance or the aggregate thereof should have a diameter of 5 nm or more. In addition, when the substance or the aggregate thereof can be approximated as a cylindrical shape such as a rod-like shape, a thin-layer shape, or a rectangular parallelepiped shape, the length of its longest side should be 10 nm or more.

Upon dispersion of the substance in the polymer, when the substance or the aggregate thereof in the polymer can be approximated as a spherical shape such as a sphere, a cube, or an amorphous shape, and the substance or the aggregate thereof which is of a spherical shape has a diameter of 5 nm or more, the substance can be regarded as being incompatible with the polymer. In addition, when the substance or the aggregate thereof in the polymer can be approximated as a cylindrical shape such as a rod-like shape, a thin-layer shape, or a rectangular parallelepiped shape, and the length of the longest side of the substance or the aggregate thereof which is of a cylindrical shape is 10 nm or more, the substance can be regarded as being incompatible with the polymer.

As a method of dispersing the layered inorganic compound (f) in the polymer (X), there are given, for example: a method involving adding or uniformly dispersing the photopolymerization initiator and the layered inorganic compound (f) in the polymerizable monomer (m) for constituting the polymer (X), then coating a base material film such as a PET film with the resultant at a thickness of about 10 to 500 μm, and performing polymerization by UV light irradiation with a black-light lamp in an inert gas such as nitrogen or in the absence of the influence of oxygen with a cover film; and a method involving producing in advance the polymer (X) by any appropriate method such as solution polymerization or UV light polymerization, adding, to a solvent system having the polymer (X) dissolved in a solvent, the layered inorganic compound (f), followed by uniform dispersion by stirring or the like, and applying the dispersion onto a base material film such as a PET film so as to have a thickness of about 10 to 500 μm after the removal of the solvent by drying.

The polymerizable composition (α) can be prepared by uniformly mixing/dispersing the respective components. The polymerizable composition (α) is preferably provided with a moderate viscosity suitable for an application operation because the composition is typically formed into a sheet shape by, for example, being applied onto a base material. The viscosity of the polymerizable composition (α) can be prepared by, for example, compounding any one of the various polymers such as an acrylic rubber and a thickening additive, or polymerizing part of the polymerizable monomer (m) in the polymerizable composition (α) through photoirradiation, heating, or the like. It should be noted that a desired viscosity is as described below. A viscosity set with a BH viscometer under the conditions of a rotor of a No. 5 rotor, a rotational frequency of 10 rpm, and a measurement temperature of 30° C. is preferably 5 to 50 Pa·s, more preferably 10 to 40 Pa·s. When the viscosity is less than 5 Pa·s, the liquid may flow when applied onto the base material. When the viscosity exceeds 50 Pa·s, the viscosity is so high that it may become difficult to apply the liquid.

(2-2. Polymerizable Composition Layer (a))

The polymerizable composition layer (a) is a layer formed of the polymerizable composition (α).

The thickness of the polymerizable composition layer (a) is, for example, preferably 10 to 1,000 μm, more preferably 15 to 800 μm, still more preferably 20 to 600 μm. When the thickness of the polymerizable composition layer (a) is less than 10 μm, it may be unable to perform uniform application or the polymer member to be obtained may not have a resistance to cigarette burns. When the thickness of the polymerizable composition layer (a) exceeds 1,000 μm, waviness occurs in the polymer member to be obtained, and hence a smooth polymer member may not be obtained.

The polymerizable composition (α) contains the polymerizable monomer (m) and the layered inorganic compound (f). The content ratio of the layered inorganic compound (f) is preferably 5 to 50 parts by weight, more preferably 10 to 45 parts by weight, still more preferably 15 to 40 parts by weight with respect to 100 parts by weight of the polymerizable monomer (m). When the content ratio of the layered inorganic compound (f) exceeds 50 parts by weight with respect to 100 parts by weight of the polymerizable monomer (m), the production of the polymer member of the present invention may be difficult, or the polymer member to be obtained may have a problem of a reduction in strength. When the content ratio of the layered inorganic compound (f) is less than 5 parts by weight with respect to 100 parts by weight of the polymerizable monomer (m), the polymer member to be obtained may not have a resistance to cigarette burns.

<2-3. Cover Film>

Upon production of the polymer member of the present invention, a cover film can be used as the support of the polymerizable composition layer (a). The cover film may have peelability or may not have peelability. It should be noted that when a photopolymerization reaction is used in the polymerizing step, oxygen in the air is preferably blocked with the cover film in the polymerizing step because the reaction is inhibited by oxygen in the air.

As the cover film, any appropriate cover film can be adopted as long as the cover film is a thin sheet which has low oxygen permeation. When a photopolymerization reaction is used, a preferred cover film is a transparent film such as any appropriate release paper. Specific examples of the cover film include a base material having a layer release-treated (peel-treated) with a release treatment agent (peel treatment agent) on at least one of its surfaces, a low-adhesive base material formed of a fluorine-based polymer (e.g., a polytetrafluoroethylene, a polychlorotrifluoroethylene, a polyvinyl fluoride, a polyvinylidene fluoride, a copolymer of tetrafluoroethylene and hexafluoropropylene, or a copolymer of chlorofluoroethylene and vinylidene fluoride), and a low-adhesive base material formed of a non-polar polymer (e.g., an olefin-based resin such as a polyethylene or a polypropylene). It should be noted that both surfaces can be utilized as release surfaces in the case of the low-adhesive base material, while the release-treated layer surface can be utilized as a release surface (release-treated surface) in the case of the base material having a release-treated layer.

For example, a cover film having a release-treated layer formed on at least one surface of a base material for a cover film (base material having a release-treated layer) may be used as the cover film, or the base material for a cover film may be used as it is as the cover film.

Examples of the base material for a cover film include: a plastic-based base material film (synthetic resin film) such as a polyester film (e.g., a polyethylene terephthalate film), an olefin-based resin film (e.g., a polyethylene film or a polypropylene film), a polyvinyl chloride film, a polyimide film, a polyamide film (nylon film), and a rayon film; papers (e.g., woodfree paper, Japanese paper, kraft paper, glassine paper, synthetic paper, and top-coated paper); and a multi-layered laminate obtained by lamination or co-extrusion thereof (laminate of 2 to 3 layers). As the base material for a cover film, a base material for a cover film obtained by using a plastic-based base material film (in particular, a polyethylene terephthalate film) having high transparency is particularly preferred.

Any appropriate release treatment agent can be adopted as the release treatment agent. Examples of the release treatment agent include a silicone-based release treatment agent, a fluorine-based release treatment agent, and a long-chain alkyl-based release treatment agent. The release treatment agents may be used alone or in combination. It should be noted that the cover film subjected to release treatment with the release treatment agent can be formed by any appropriate forming method, for example.

Any appropriate thickness can be adopted as the thickness of the cover film. The thickness of the cover film is, for example, preferably 12 to 250 μm, more preferably 20 to 200 μm in terms of handleability and economic efficiency.

The cover film may have any form of a single layer and a laminate.

<2-4. Polymerizing Step>

The polymerizing step is a step of polymerizing the syrupy polymerizable composition layer (a). Any appropriate method can be adopted as a polymerization method in the polymerizing step as long as the polymerization of the polymerizable monomer can be performed by the method.

The polymerization method in the polymerizing step is, for example, a polymerization method involving photoirradiation. Any appropriate apparatus or condition can be adopted as a light source, irradiation energy, an irradiation method, an irradiation time, or the like in the polymerization method involving photoirradiation.

An active energy ray to be used in the photoirradiation is, for example, an ionizing radiation such as an α-ray, a β-ray, a γ-ray, a neutron beam, or an electron beam, or UV light. Of those, UV light is preferred. It should be noted that any appropriate apparatus or condition can be adopted as irradiation energy, an irradiation method, an irradiation time, or the like for the active energy ray.

The irradiation with the active energy ray is specifically, for example, UV light irradiation with a black-light lamp, a chemical lamp, a high-pressure mercury lamp, or a metal halide lamp.

Heating can be performed in the polymerizing step. Any appropriate heating method can be adopted for the heating. Examples of the heating method include a heating method involving using an electrothermal heater and a heating method involving using an electromagnetic wave such as an infrared ray.

### 3. Shape of Polymer Member

Any appropriate shape can be adopted as the shape of the polymer member of the present invention. Examples of the shape of the polymer member of the present invention include a sheet shape and a tape shape. The polymer member of the present invention may have such a shape that the member of a sheet shape or a tape shape is wound in a roll shape. Alternatively, the polymer member of the present invention may have such a shape that members of sheet shapes or tape shapes are laminated.

The polymer member of the present invention can be used as a pressure-sensitive adhesive tape or a pressure-sensitive adhesive sheet by imparting pressure-sensitive adhesive property to the polymer (X). It should be noted that the “pressure-sensitive adhesive tape” and the “pressure-sensitive adhesive sheet” may be collectively referred to as “tape” or “sheet” in a simple manner.

The polymer member of the present invention can be used as a pressure-sensitive adhesive tape or a pressure-sensitive adhesive sheet by further providing the polymer member of the present invention with a pressure-sensitive adhesive layer formed of any appropriate pressure-sensitive adhesive (e.g., an acrylic pressure-sensitive adhesive, a rubber-based pressure-sensitive adhesive, a vinyl alkyl ether-based pressure-sensitive adhesive, a silicone-based pressure-sensitive adhesive, a polyester-based pressure-sensitive adhesive, a polyamide-based pressure-sensitive adhesive, a urethane-based pressure-sensitive adhesive, fluorine-based pressure-sensitive adhesive, or an epoxy-based pressure-sensitive adhesive).

The polymer member of the present invention may have any other layer as long as the effect of the present invention is not impaired.

The surface of the polymer member of the present invention may be protected with a cover film. Upon use of the polymer member of the present invention, the cover film may be peeled or may maintain its state without being peeled to constitute part of the polymer member of the present invention.

### 4. Cigarette-Resistant Article

A cigarette-resistant article is obtained by attaching the polymer member of the present invention to an adherend, and has excellent resistance to cigarette burns. For example, paper, lumber, a plastic material, a metal, a plaster board, glass, or a composite containing two or more thereof can be used as the adherend. The polymer member of the present invention is attached to at least part of the adherend. It should be noted that the adherend may be a printed matter provided with a pattern layer on at least one surface of the sheet, or may be an adherend having design.

The polymer member of the present invention is extremely excellent in transparency, and hence the resistance to cigarette burns can be provided to an adherend while the design of the adherend is secured. Therefore, the use of the polymer member of the present invention allows the design of the adherend to be sufficiently expressed, and a cigarette-resistant article excellent in design can be provided.

Examples of the paper as the adherend include woodfree paper, Japanese paper, kraft paper, glassine paper, synthetic paper, and top-coated paper.

Examples of the lumber as the adherend include: broadleaf trees such as oak, paulownia wood, keyaki, teak, and rosewood; coniferous trees such as Japanese cedar, Japanese cypress, pine, and hiba false arborvitae; assembles; and plywood.

Examples of the plastic material as the adherend include an acrylic resin, a polyester (e.g., a polyethylene terephthalate), an olefin-based resin (e.g., a polyethylene, a polypropylene, or a polystyrene), a vinyl chloride resin, an epoxy resin, a vinyl ether-based resin, a urethane-based resin, a polycarbonate resin, an ABS resin, a silicone resin, a phenol resin, and an AS resin.

Upon lamination of the polymer member of the present invention and the printed matter, the member and the printed matter may be attached to each other by applying any appropriate pressure-sensitive adhesive by any appropriate application method. When the polymer member has pressure-sensitive adhesive property, the member may be attached to the printed matter without being treated. A method of attaching the polymer member of the present invention and the printed matter is, for example, a method involving attaching the member and the printed matter with a laminator. The cigarette-resistant printed matter thus obtained can be attached to a wall surface or glass surface of a railway vehicle or the like, or to a wall surface, decorative board, glass surface, or the like of a housing or the like through an attachment layer, the attachment layer being provided on the surface opposite to the surface on which the polymer member of the present invention is laminated.

The polymer member of the present invention can be suitably used, for example, as a building material in each of an outer wall material, an outer wall trim material, an inner wall material, an inner wall trim material, a wall insulation material, a ceiling material, a ceiling trim material, a roofing material, a floor material, a floor trim material, a partition material, a wall material, floor material, and ceiling material for a bathroom and trim materials therefor, a wall material, floor material, and ceiling material for a kitchen and trim materials therefor, a wall material, floor material, and ceiling material for a lavatory and trim materials therefor, a pillar material and a pillar protection material, and an inner material, surface trim material, partition material, and curtain for a lavatory, room, and various doors such as a front door and a sliding door, in particular, a wall material or ceiling material for a kitchen, a partition for a clean room, in general housing including wooden housing based on a conventional construction method, a light-frame construction method, or the like, reinforced concrete housing, steel construction housing of light-gauge steel construction or heavy-gauge steel construction, and prefabricated housing, complex housing such as a superhigh-rise condominium, a high-rise condominium, a mid-rise or low-rise condominium, and an apartment building, and large building structures and public facilities such as a cafe, a restaurant, an office building, a department store, a supermarket, an indoor parking lot, a movie theater, a hotel, various sports facilities, a gymnasium, a concert hall, a domed baseball stadium or soccer stadium, an indoor soccer stadium, an indoor pool, and a factory building. In addition, the member can be used in, for example, an inner material or surface trim material for fire preventive equipment such as an exhaust duct, a fire door, or a fire shutter, a surface trim material for furniture such as a table, a surface trim material for a door, a surface trim material for window glass, a surface trim material for furniture such as a table, an antiscattering material or surface trim material for window glass, a mirror, a tile, or the like, a surface trim material for a signboard or digital signage, or a roll screen. In addition, the member can be used in a body protective material, inner or outer wall material, ceiling material, roofing material, or flooring material for a ship, aircraft, automobile, or railway vehicle, a surface protective material for a printed matter to be attached to the inside or outside of a railway vehicle, a surface protective material for an inkjet media material, an inner protective material or outer protective material for a solar cell, a protective material for a battery such as a lithium ion battery, or an electrical and electric equipment member such as a partition inside an electrical apparatus. Further, the member can be used as a peripheral tool for an ash tray, a surface trim material for a garbage box, or a protective material for the front panel or chassis of a pachinko machine. Further, the member can be used also for protecting an object having a design such as a counter in a restaurant or an advertisement by virtue of having transparency and resistance to cigarette burns.

### EXAMPLES

Hereinafter, the present invention is described in more detail by way of examples, but the present invention is not limited to these examples.

It should be noted that a biaxially stretched polyethylene terephthalate film having a thickness of 38 μm (trade name: “MRN38,” manufactured by Mitsubishi Chemical Polyester Film) one surface of which had been subjected to a silicone-based release treatment was used as each of cover films and base material films used in the following respective examples.

### Synthesis Example 1

### Preparation of Syrup (a-1) Containing Layered Inorganic Compound

30 Parts by weight of a layered clay mineral (trade name: “Lucentite SPN,” manufactured by Co-op Chemical Co., Ltd., shape: flat plate-like shape) were added to 100 parts by weight of 1,6-hexanediol diacrylate, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-1) containing a layered inorganic compound was prepared. It should be noted that the monomer mixture to which the layered clay mineral had been added became transparent as a result of the ultrasonic treatment.

### Synthesis Example 2

### Preparation of Syrup (a-2) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 50 parts by weight of 1,6-hexanediol diacrylate, 50 parts by weight of cyclohexyl acrylate, 0.2 part by weight of a photopolymerization initiator (trade name: “IRGACURE 651,” manufactured by Ciba Specialty Chemicals Inc.), and 0.2 part by weight of a photopolymerization initiator (trade name: “IRGACURE 184,” manufactured by Ciba Specialty Chemicals Inc.), and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-2) containing a layered inorganic compound was prepared. It should be noted that the monomer mixture to which the layered clay mineral had been added became transparent as a result of the ultrasonic treatment.

### Synthesis Example 3

### Preparation of Syrup (a-3) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 10 parts by weight of 1,6-hexanediol diacrylate and 90 parts by weight of cyclohexyl acrylate, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-3) containing a layered inorganic compound was prepared. It should be noted that the monomer mixture to which the layered clay mineral had been added became transparent as a result of the ultrasonic treatment.

### Synthesis Example 4

### Preparation of Syrup (a-4) Containing Layered Inorganic Compound

20 Parts by weight of a layered clay mineral (trade name: “Lucentite SPN,” manufactured by Co-op Chemical Co., Ltd., shape: flat plate-like shape) were added to 100 parts by weight of 1,9-nonanediol diacrylate, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-4) containing a layered inorganic compound was prepared. It should be noted that the monomer mixture to which the layered clay mineral had been added became transparent as a result of the ultrasonic treatment.

### Synthesis Example 5

### Preparation of syrup (a-5) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 50 parts by weight of 1,6-hexanediol diacrylate and 50 parts by weight of 1,9-nonanediol diacrylate, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-5) containing a layered inorganic compound was prepared. It should be noted that the monomer mixture to which the layered clay mineral had been added became transparent as a result of the ultrasonic treatment.

### Synthesis Example 6

### Preparation of syrup (a-6) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 70 parts by weight of 1,6-hexanediol diacrylate and 30 parts by weight of trimethylolpropane triacrylate, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-6) containing a layered inorganic compound was prepared. It should be noted that the monomer mixture to which the layered clay mineral had been added became transparent as a result of the ultrasonic treatment.

### Synthesis Example 7

### Preparation of Syrup (a-7) Containing Layered Inorganic Compound

30 Parts by weight of a layered clay mineral (trade name: “Lucentite SPN,” manufactured by Co-op Chemical Co., Ltd., shape: flat plate-like shape) were added to 100 parts by weight of cyclohexyl acrylate, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-7) containing a layered inorganic compound was prepared. It should be noted that the monomer mixture to which the layered clay mineral had been added became transparent as a result of the ultrasonic treatment.

### Example 1

A syrup composition prepared by uniformly mixing 100 parts by weight of the syrup (a-1) with 0.5 part by weight of a photopolymerization initiator (trade name: “IRGACURE 819,” manufactured by Ciba Specialty Chemicals Inc.) was applied onto the peel-treated surface of the base material film so as to have a thickness of 100 μm after its curing. Thus, a syrup composition layer was formed. Then, the cover film was attached onto the layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (1) was produced.

### Example 2

100 Parts by weight of the syrup (a-2) were applied onto the peel-treated surface of the base material film so as to have a thickness of 100 μm after its curing. Thus, a syrup composition layer was formed. Then, the cover film was attached onto the layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (2) was produced.

### Example 3

A syrup composition prepared by uniformly mixing 100 parts by weight of the syrup (a-3) with 0.5 part by weight of a photopolymerization initiator (trade name: “IRGACURE 819,” manufactured by Ciba Specialty Chemicals Inc.) was applied onto the peel-treated surface of the base material film so as to have a thickness of 100 μm after its curing. Thus, a syrup composition layer was formed. Then, the cover film was attached onto the layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (3) was produced.

### Example 4

A syrup composition prepared by uniformly mixing 100 parts by weight of the syrup (a-4) with 0.5 part by weight of a photopolymerization initiator (trade name: “IRGACURE 819,” manufactured by Ciba Specialty Chemicals Inc.) was applied onto the peel-treated surface of the base material film so as to have a thickness of 100 μm after its curing. Thus, a syrup composition layer was formed. Then, the cover film was attached onto the layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (4) was produced.

### Example 5

A syrup composition prepared by uniformly mixing 100 parts by weight of the syrup (a-5) with 0.5 part by weight of a photopolymerization initiator (trade name: “IRGACURE 819,” manufactured by Ciba Specialty Chemicals Inc.) was applied onto the peel-treated surface of the base material film so as to have a thickness of 100 μm after its curing. Thus, a syrup composition layer was formed. Then, the cover film was attached onto the layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (5) was produced.

### Example 6

A syrup composition prepared by uniformly mixing 100 parts by weight of the syrup (a-6) with 0.5 part by weight of a photopolymerization initiator (trade name: “IRGACURE 819,” manufactured by Ciba Specialty Chemicals Inc.) was applied onto the peel-treated surface of the base material film so as to have a thickness of 100 μm after its curing. Thus, a syrup composition layer was formed. Then, the cover film was attached onto the layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (6) was produced.

### Example 7

A syrup composition prepared by uniformly mixing 100 parts by weight of the syrup (a-1) with 0.5 part by weight of a photopolymerization initiator (trade name: “IRGACURE 819,” manufactured by Ciba Specialty Chemicals Inc.) was applied onto the peel-treated surface of the base material film so as to have a thickness of 20 μm after its curing. Thus, a syrup composition layer was formed. Then, the cover film was attached onto the layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (7) was produced.

### Example 8

A syrup composition prepared by uniformly mixing 100 parts by weight of the syrup (a-1) with 0.5 part by weight of a photopolymerization initiator (trade name: “IRGACURE 819,” manufactured by Ciba Specialty Chemicals Inc.) was applied onto the peel-treated surface of the base material film so as to have a thickness of 500 μm after its curing. Thus, a syrup composition layer was formed. Then, the cover film was attached onto the layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (8) was produced.

### Comparative Example 1

A syrup composition prepared by uniformly mixing 100 parts by weight of the syrup (a-7) with 0.5 part by weight of a photopolymerization initiator (trade name: “IRGACURE 819,” manufactured by Ciba Specialty Chemicals Inc.) was applied onto the peel-treated surface of the base material film so as to have a thickness of 500 μm after its curing. Thus, a syrup composition layer was formed. Then, the cover film was attached onto the layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a polymer sheet (C1) was produced.

The polymer sheets of Examples 1 to 8 and Comparative Example 1 were subjected to the following evaluations. Table 1 shows the results.

<Transparency>

The cover film and the base material film on both surfaces of a polymer sheet were peeled, and then the total light transmittance and haze value of the remainder were measured with a haze meter (“HM-150” manufactured by MURAKAMI COLOR RESEARCH LABORATORY) in conformity with JIS7361.

<Resistance to Cigarette Burns>

Copy paper White Economy 314-048 (manufactured by Biznet) (which served as a base) was placed on a K-Dry (manufactured by NIPPON PAPER CRECIA Co., LTD.) folded into quarters in order for heat conduction toward a lower portion to be prevented. On the resultant was placed a polymer sheet whose cover film and base material film on both surfaces thereof had been peeled with its polymer layer as an upper surface, and then a live cigarette was laid on the polymer sheet for about 30 seconds. After that, the ash of the cigarette was wiped off with a K-Dry impregnated with water, and then evaluation was made on the basis of the following criteria. The case where the evaluation was made with any of symbol “∘” and symbol “Δ” was defined as “having a resistance to cigarette burns” in the present invention.

∘: The polymer sheet is not marked with a singe on the surface, and the base also has no singe.
Δ: The polymer sheet is marked with a visually observable singe on the surface, but the base has no singe.

x: The polymer sheet is perforated with a hole, and the base is singed.

TABLE 1

| | | | Resistance to |
|---|---|---|---|
| | Total light | | cigarette |
| | transmittance (%) | Haze value (%) | burns |
| Example 1 | 92.1 | 1.7 | ∘ |
| Example 2 | 92.1 | 1.8 | ∘ |
| Example 3 | 91.4 | 1.7 | ∘ |
| Example 4 | 91.9 | 1.9 | ∘ |
| Example 5 | 91.8 | 1.9 | ∘ |
| Example 6 | 91.6 | 1.8 | ∘ |
| Example 7 | 92.3 | 1.7 | ∘ |
| Example 8 | 90.5 | 1.9 | ∘ |
| Comparative | 91.4 | 1.8 | x |
| Example 1 | | | |

It is found that the polymer sheets of Examples 1 to 8 each have a resistance to cigarette burns and transparency.

### Example 9

A syrup composition prepared by uniformly mixing 100 parts by weight of the syrup (a-1) with 0.5 part by weight of a photopolymerization initiator (trade name: “IRGACURE 819,” manufactured by Ciba Specialty Chemicals Inc.) was applied onto one surface of a biaxially stretched polyester film (trade name: “COSMOSHINE A4100,” manufactured by TOYOBO CO., LTD., thickness: 100 μm) so as to have a thickness of 25 μm after its curing. Thus, a syrup composition layer was formed. Then, the cover film was attached onto the layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (9) was produced.

The polymer sheets of Example 1 and Example 9 were subjected to the following evaluations. Table 2 shows the results.

<Transparency>

The cover film and the base material film on both surfaces of a polymer sheet were peeled, and then the total light transmittance and haze value of the remainder were measured with a haze meter (“HM-150” manufactured by MURAKAMI COLOR RESEARCH LABORATORY) in conformity with JIS7361.

<Resistance to Cigarette Burns>

Copy paper White Economy 314-048 (manufactured by Biznet) (which served as a base) was placed on a K-Dry (manufactured by NIPPON PAPER CRECIA Co., LTD.) folded into quarters in order for heat conduction toward a lower portion to be prevented. On the resultant was placed a polymer sheet whose cover film and base material film on both surfaces thereof had been peeled with its polymer layer as an upper surface, and then a live cigarette was laid on the polymer sheet for about 30 seconds. After that, the ash of the cigarette was wiped off with a K-Dry impregnated with water, and then evaluation was made on the basis of the following criteria. The case where the evaluation was made with any of symbol “∘” and symbol “Δ” was defined as “having a resistance to cigarette burns” in the present invention.

∘: The polymer sheet is not marked with a singe on the surface, and the base also has no singe.
Δ: The polymer sheet is marked with a visually observable singe on the surface, but the base has no singe.
x: The polymer sheet is perforated with a hole, and the base is singed.

<Mechanical Strength>

A test piece having a width of 10 mm and a length of 10 mm was measured for its tensile strength by being pulled with a tensile tester (manufactured by Minebea Co., Ltd., “Tensile and Compression Testing Machine TCM-1KNB”) at 23° C. and a rate of pulling of 50 mm/min.

TABLE 2

| | Resistance to | Total light | | Tensile |
|---|---|---|---|---|
| | cigarette | transmittance | Haze value | strength |
| | burns | (%) | (%) | (N/mm²) |
| Example 9 | ∘ | 90.5 | 6.4 | 110.2 |
| Example 1 | ∘ | 92.1 | 1.7 | 23.8 |

It is found that the polymer sheet of Example 9 has high strength, is excellent in transparency and flexibility, and can impart high strength and resistance to cigarette burns to various adherends by being attached to the various adherends.

### Example 10

A syrup composition prepared by uniformly mixing 100 parts by weight of the syrup (a-1) with 0.5 part by weight of a photopolymerization initiator (trade name: “IRGACURE 819,” manufactured by Ciba Specialty Chemicals Inc.) was applied onto both surfaces of a glass cloth (trade name: “E10T,” manufactured by UNITIKA LTD., thickness: 100 μm) so as to have a thickness of 50 μm after its curing. Thus, a syrup composition layer was formed. Then, the cover film was attached onto the layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (10) was produced.

The polymer sheets of Example 1 and Example 10 were subjected to the following-evaluations. Table 3 shows the results.

<Transparency>

The cover film and the base material film on both surfaces of a polymer sheet were peeled, and then the total light transmittance and haze value of the remainder were measured with a haze meter (“HM-150” manufactured by MURAKAMI COLOR RESEARCH LABORATORY) in conformity with JIS7361.

<Resistance to Cigarette Burns>

Copy paper White Economy 314-048 (manufactured by Biznet) (which served as a base) was placed on a K-Dry (manufactured by NIPPON PAPER CRECIA Co., LTD.) folded into quarters in order for heat conduction toward a lower portion to be prevented. On the resultant was placed a polymer sheet whose cover film and base material film on both surfaces thereof had been peeled with its polymer layer as an upper surface, and then a live cigarette was laid on the polymer sheet for about 30 seconds. After that, the ash of the cigarette was wiped off with a K-Dry impregnated with water, and then evaluation was made on the basis of the following criteria. The case where the evaluation was made with any of symbol “∘” and symbol “Δ” was defined as “having a resistance to cigarette burns” in the present invention.

∘: The polymer sheet is not marked with a singe on the surface, and the base also has no singe.
Δ: The polymer sheet is marked with a visually observable singe on the surface, but the base has no singe.
x: The polymer sheet is perforated with a hole, and the base is singed.

<Heat-Generating Property Test>

A heat-generating property test was performed in conformity with the cone calorimeter method of ISO 5660-1. A total quantity of heat to be generated and a duration time of a heat generation rate of 200 kW/m² or more in the test, and the external appearance of the polymer sheet after the test (visual observation) were evaluated. Evaluation criteria for the external appearance of the polymer sheet after the test were as follows.

∘: No rupture is present.
x: Rupture is present.

TABLE 3

| | | | | Total quantity | Duration time of | |
|---|---|---|---|---|---|---|
| | Resistance | Total light | | of heat to be | heat generation | External |
| | to cigarette | transmittance | Haze value | generated | rate of 200 kW/m² | appearance |
| | burns | (%) | (%) | (MJ/m²) | or more (seconds) | of sheet |
| Example 10 | ∘ | 82.2 | 91.6 | 2.32 | 0 | ∘ |
| Example 1 | ∘ | 92.1 | 1.7 | 3.33 | 0 | x |

It is found that the polymer sheet of Example 10 has a high degree of flame retardancy, is excellent in transparency and flexibility, and can impart a resistance to cigarette burns to various adherends by being attached to the various adherends.

### Synthesis Example 8

### Preparation of Syrup (a-8) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 10 parts by weight of 1,6-hexanediol diacrylate and 90 parts by weight of hydroxyethyl acrylate, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-8) containing a layered inorganic compound was prepared. It should be noted that the monomer mixture to which the layered clay mineral had been added became transparent as a result of the ultrasonic treatment.

### Synthesis Example 9

### Preparation of Syrup (a-9) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 30 parts by weight of 1,6-hexanediol diacrylate and 70 parts by weight of hydroxyethyl acrylate, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-9) containing a layered inorganic compound was prepared. It should be noted that the monomer mixture to which the layered clay mineral had been added became transparent as a result of the ultrasonic treatment.

### Synthesis Example 10

### Preparation of Syrup (a-10) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 50 parts by weight of 1,6-hexanediol diacrylate and 50 parts by weight of hydroxyethyl acrylate, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-10) containing a layered inorganic compound was prepared. It should be noted that the monomer mixture to which the layered clay mineral had been added became transparent as a result of the ultrasonic treatment.

### Synthesis Example 11

### Preparation of Syrup (a-11) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 10 parts by weight of 1,6-hexanediol diacrylate and 90 parts by weight of acrylic acid, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-11) containing a layered inorganic compound was prepared. It should be noted that the monomer mixture to which the layered clay mineral had been added became transparent as a result of the ultrasonic treatment.

### Synthesis Example 12

### Preparation of Syrup (a-12) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 30 parts by weight of 1,6-hexanediol diacrylate and 70 parts by weight of acrylic acid, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-12) containing a layered inorganic compound was prepared. It should be noted that the monomer mixture to which the layered clay mineral had been added became transparent as a result of the ultrasonic treatment.

### Synthesis Example 13

### Preparation of Syrup (a-13) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 50 parts by weight of 1,6-hexanediol diacrylate and 50 parts by weight of acrylic acid, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-13) containing a layered inorganic compound was prepared. It should be noted that the monomer mixture to which the layered clay mineral had been added became transparent as a result of the ultrasonic treatment.

### Synthesis Example 14

### Preparation of Syrup (a-14) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 10 parts by weight of 1,6-hexanediol diacrylate and 90 parts by weight of 2-methoxyethyl acrylate, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-14) containing a layered inorganic compound was prepared. It should be noted that the monomer mixture to which the layered clay mineral had been added became transparent as a result of the ultrasonic treatment.

### Synthesis Example 15

### Preparation of Syrup (a-15) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 30 parts by weight of 1,6-hexanediol diacrylate and 70 parts by weight of 2-methoxyethyl acrylate, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-15) containing a layered inorganic compound was prepared. It should be noted that the monomer mixture to which the layered clay mineral had been added became transparent as a result of the ultrasonic treatment.

### Synthesis Example 16

### Preparation of Syrup (a-16) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 30 parts by weight of 1,6-hexanediol diacrylate and 70 parts by weight of N-vinylpyrrolidone, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-16) containing a layered inorganic compound was prepared. It should be noted that the monomer mixture to which the layered clay mineral had been added became transparent as a result of the ultrasonic treatment.

### Synthesis Example 17

### Preparation of Syrup (a-17) Containing Layered Inorganic Compound

30 Parts by weight of a layered clay mineral (trade name: “Lucentite SPN,” manufactured by Co-op Chemical Co., Ltd., shape: flat plate-like shape) were added to 100 parts by weight of 1,6-hexanediol diacrylate, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-17) containing a layered inorganic compound was prepared. It should be noted that the monomer mixture to which the layered clay mineral had been added became transparent as a result of the ultrasonic treatment.

### Synthesis Example 18

### Preparation of Syrup (a-18) Containing Layered Inorganic Compound

30 Parts by weight of a layered clay mineral (trade name: “Lucentite SPN,” manufactured by Co-op Chemical Co., Ltd., shape: flat plate-like shape) were added to a monomer mixture formed of 60 parts by weight of 1,6-hexanediol diacrylate and 40 parts by weight of hydroxyethyl acrylate, and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-18) containing a layered inorganic compound was prepared. It should be noted that the monomer mixture to which the layered clay mineral had been added became transparent as a result of the ultrasonic treatment.

### Synthesis Example 19

### Preparation of Syrup (b-1)

90 Parts by weight of 2-ethylhexyl acrylate, 10 parts by weight of acrylic acid, 0.05 part by weight of a photopolymerization initiator (trade name: “IRGACURE 651,” manufactured by Ciba Specialty Chemicals Inc.), and 0.05 part by weight of a photopolymerization initiator (trade name: “IRGACURE 184,” manufactured by Ciba Specialty Chemicals Inc.) were stirred in a four-necked separable flask provided with a stirring machine, a temperature gauge, a nitrogen gas-introducing tube, and a cooling tube until the mixture became uniform. After that, bubbling was performed with a nitrogen gas for 1 hour to remove dissolved oxygen. After that, UV light was applied from the outside of the flask by using a black-light lamp to perform polymerization. At the time point when a moderate viscosity was obtained, the lamp was turned off and the blowing of nitrogen was stopped. Thus, a syrupy composition having a rate of polymerization of 7% part of which had been polymerized was prepared (the composition is herein after referred to as “syrup (b-1)”).

### Synthesis Example 20

### Production of Pressure-Sensitive Adhesive Sheet (A)

A photopolymerizable composition formed of 100 parts by weight of the syrup (b-1) and 0.08 part by weight of 1,6-hexanediol diacrylate was applied onto a peel-treated PET film so as to have a thickness of 50 μm after its curing. Thus, a photopolymerizable composition layer was formed. Next, the cover film was attached onto the formed photopolymerizable composition layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a pressure-sensitive adhesive-sheet (A) was produced.

### Example 11

A syrup composition prepared by uniformly mixing 130 parts by weight of the syrup (a-8) with 0.5 part by weight of a photopolymerization initiator (trade name: “IRGACURE 819,” manufactured by Ciba Specialty Chemicals Inc.) was applied onto the pressure-sensitive adhesive sheet (A) so that a thickness including that of the pressure-sensitive adhesive sheet (A) was 125 μm after its curing. Thus, a syrup composition layer was formed. Then, the cover film was attached onto the formed syrup composition layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (11) was produced.

### Example 12

A syrup composition prepared by uniformly mixing 130 parts by weight of the syrup (a-9) with 0.5 part by weight of a photopolymerization initiator (trade name: “IRGACURE 819,” manufactured by Ciba Specialty Chemicals Inc.) was applied onto the pressure-sensitive adhesive sheet (A) so that a thickness including that of the pressure-sensitive adhesive sheet (A) was 125 μm after its curing. Thus, a syrup composition layer was formed. Then, the cover film was attached onto the formed syrup composition layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (12) was produced.

### Example 13

A syrup composition prepared by uniformly mixing 130 parts by weight of the syrup (a-10) with 0.5 part by weight of a photopolymerization initiator (trade name: “IRGACURE 819,” manufactured by Ciba Specialty Chemicals Inc.) was applied onto the pressure-sensitive adhesive sheet (A) so that a thickness including that of the pressure-sensitive adhesive sheet (A) was 125 μm after its curing. Thus, a syrup composition layer was formed. Then, the cover film was attached onto the formed syrup composition layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (13) was produced.

### Example 14

A syrup composition prepared by uniformly mixing 130 parts by weight of the syrup (a-11) with 0.5 part by weight of a photopolymerization initiator (trade name: “IRGACURE 819,” manufactured by Ciba Specialty Chemicals Inc.) was applied onto the pressure-sensitive adhesive sheet (A) so that a thickness including that of the pressure-sensitive adhesive sheet (A) was 125 μm after its curing. Thus, a syrup composition layer was formed. Then, the cover film was attached onto the formed syrup composition layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (14) was produced.

### Example 15

A syrup composition prepared by uniformly mixing 130 parts by weight of the syrup (a-12) with 0.5 part by weight of a photopolymerization initiator (trade name: “IRGACURE 819,” manufactured by Ciba Specialty Chemicals Inc.) was applied onto the pressure-sensitive adhesive sheet (A) so that a thickness including that of the pressure-sensitive adhesive sheet (A) was 125 μm after its curing. Thus, a syrup composition layer was formed. Then, the cover film was attached onto the formed syrup composition layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (15) was produced.

### Example 16

A syrup composition prepared by uniformly mixing 130 parts by weight of the syrup (a-13) with 0.5 part by weight of a photopolymerization initiator (trade name: “IRGACURE 819,” manufactured by Ciba Specialty Chemicals Inc.) was applied onto the pressure-sensitive adhesive sheet (A) so that a thickness including that of the pressure-sensitive adhesive sheet (A) was 125 μm after its curing. Thus, a syrup composition layer was formed. Then, the cover film was attached onto the formed syrup composition layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (16) was produced.

### Example 17

A syrup composition prepared by uniformly mixing 130 parts by weight of the syrup (a-14) with 0.5 part by weight of a photopolymerization initiator (trade name: “IRGACURE 819,” manufactured by Ciba Specialty Chemicals Inc.) was applied onto the pressure-sensitive adhesive sheet (A) so that a thickness including that of the pressure-sensitive adhesive sheet (A) was 125 μm after its curing. Thus, a syrup composition layer was formed. Then, the cover film was attached onto the formed syrup composition layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (17) was produced.

### Example 18

A syrup composition prepared by uniformly mixing 130 parts by weight of the syrup (a-15) with 0.5 part by weight of a photopolymerization initiator (trade name: “IRGACURE 819,” manufactured by Ciba Specialty Chemicals Inc.) was applied onto the pressure-sensitive adhesive sheet (A) so that a thickness including that of the pressure-sensitive adhesive sheet (A) was 125 μm after its curing. Thus, a syrup composition layer was formed. Then, the cover film was attached onto the formed syrup composition layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (18) was produced.

### Example 19

A syrup composition prepared by uniformly mixing 130 parts by weight of the syrup (a-16) with 0.5 part by weight of a photopolymerization initiator (trade name: “IRGACURE 819,” manufactured by Ciba Specialty Chemicals Inc.) was applied onto the pressure-sensitive adhesive sheet (A) so that a thickness including that of the pressure-sensitive adhesive sheet (A) was 125 μm after its curing. Thus, a syrup composition layer was formed. Then, the cover film was attached onto the formed syrup composition layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (19) was produced.

### Example 20

A syrup composition prepared by uniformly mixing 130 parts by weight of the syrup (a-17) with 0.5 part by weight of a photopolymerization initiator (trade name: “IRGACURE 819,” manufactured by Ciba Specialty Chemicals Inc.) was applied onto the pressure-sensitive adhesive sheet (A) so that a thickness including that of the pressure-sensitive adhesive sheet (A) was 125 μm after its curing. Thus, a syrup composition layer was formed. Then, the cover film was attached onto the formed syrup composition layer in such a manner that its release-treated surface was in contact with the layer, and then both surfaces of the resultant were simultaneously irradiated with UV light (illuminance: 5 mW/cm²) by using a black-light-lamp for 5 minutes to cure the layer. Thus, a cigarette-resistant polymer sheet (20) was produced.

### Example 21

A syrup composition prepared by uniformly mixing 130 parts by weight of the syrup (a-18) with 0.5 part by weight of a photopolymerization initiator (trade name: “IRGACURE 819,” manufactured by Ciba Specialty Chemicals Inc.) was applied onto the pressure-sensitive adhesive sheet (A) so that a thickness including that of the pressure-sensitive adhesive sheet (A) was 125 μm after its curing. Thus, a syrup composition layer was formed. Then, the cover film was attached onto the formed syrup composition layer in such a manner that its release-treated surface was in contact with the layer, and then both surfaces of the resultant were simultaneously irradiated with UV light (illuminance: 5 mW/cm²) by using a black-light lamp for 5 minutes to cure the layer. Thus, a cigarette-resistant polymer sheet (21) was produced.

The polymer sheets of Examples 11 to 21 were subjected to the following evaluations. Table 4 shows the results.

<Resistance to Cigarette Burns*1>

Copy paper White Economy 314-048 (manufactured by Biznet) was placed on a plywood sheet in order for heat conduction toward a lower portion to be prevented, and the pressure-sensitive adhesive sheet (A) side of the polymer sheet was attached to the copy paper. A live cigarette was pressed against the surface on the polymer layer side for 5 seconds. After that, the ash of the cigarette was wiped off with a K-Dry (manufactured by NIPPON PAPER CRECIA Co., LTD.) impregnated with water, and then evaluation was made on the basis of the following criteria. The case where the evaluation was made with symbol “∘” was defined as “having a resistance to cigarette burns” in the present invention.

∘: The polymer sheet is not marked with a singe on the surface, and the base also has no singe.
x: The polymer sheet is marked with a singe on the surface, or the base has a singe.

<Peelability*2>

The pressure-sensitive adhesive sheet (A) side of a polymer sheet cut so as to have a width of 10 mm and a length of 70 mm was attached to a glass plate whose surface had been wiped three times with Kimwipe impregnated with ethyl acetate by rolling a 2-kg roller from end to end once. The resultant was stored under a room temperature atmosphere for 24 hours, and was then subjected to a peel test of 50 mm or more by being peeled with a tensile tester (manufactured by Minebe a Co., Ltd., Model TG-1kN) in a direction of 90° at a rate of 50 mm/min, and was evaluated on the basis of the following criteria.

∘: Peeling of 50 mm can be performed without the breakage of the polymer sheet during the peel test.
x: The breakage of the polymer sheet occurs during the process of peeling of 50 mm or more.

<Peelability after Immersion in Water*3>

The pressure-sensitive adhesive sheet (A) of a polymer sheet cut so as to have a width of 10 mm and a length of 70 mm was attached to a glass plate whose surface had been wiped three times with Kimwipe impregnated with ethyl acetate by rolling a 2-kg roller from end to end once. The resultant was stored under a room temperature atmosphere for 24 hours, and was then immersed in distilled water for 3 minutes or 5 minutes. After that, the polymer sheet was taken out, and distilled water attached on the surface of the polymer sheet was removed with Kimwipe. Then, the polymer sheet was subjected to a peel test of 50 mm or more by being peeled with a tensile tester (manufactured by Minebe a Co., Ltd., Model TG-1kN) in a direction of 90° at a rate of 50 mm/min, and was evaluated on the basis of the following criteria.

∘: Peeling of 50 mm can be performed without the breakage of the polymer sheet during the peel test.
x: The breakage of the polymer sheet occurs during the process of peeling of 50 mm or more.
-: No data

TABLE 4

| | | | Peelability after immersion | |
|---|---|---|---|---|
| | | | in water*3 | |
| | Resistance to | | Immersion in | Immersion in |
| | cigarette | | water for 3 | water for 5 |
| | burns*1 | Peelability*2 | minutes | minutes |
| Example 11 | ∘ | x | ∘ | ∘ |
| Example 12 | ∘ | x | — | ∘ |
| Example 13 | ∘ | x | — | ∘ |
| Example 14 | ∘ | x | — | ∘ |
| Example 15 | ∘ | x | — | ∘ |
| Example 16 | ∘ | x | — | ∘ |
| Example 17 | ∘ | x | — | ∘ |
| Example 18 | ∘ | x | — | ∘ |
| Example 19 | ∘ | x | — | ∘ |
| Example 20 | ∘ | x | — | x |
| Example 21 | ∘ | x | — | x |

It can be confirmed that each of the polymer sheets of Examples 11 to 19 has a resistance to cigarette burns and has peelability after immersion in water, though having no re-peelability in the peel test under a state in which water is not utilized, where the breakage of the sample occurs during the process of peeling, i.e., can express satisfactory re-peelability based on the utilization of water.

### INDUSTRIAL APPLICABILITY

The polymer member of the present invention can impart the resistance to cigarette burns to various adherends by being attached to the various adherends.

### REFERENCE SIGNS LIST

100 polymer member
B polymer layer
L base material layer
M inorganic base material
N pressure-sensitive adhesion layer
X polymer
f layered inorganic compound

1. A polymer member with a resistance to cigarette burns, comprising a polymer layer, wherein:
the polymer layer contains a layered inorganic compound (f) in a polymer (X); and
the polymer (X) contains a cross-linked polymer.

2. A polymer member according to claim 1, wherein the cross-linked polymer is obtained by polymerizing a polymerizable monomer containing a polyfunctional monomer.

3. A polymer member according to claim 2, wherein a content ratio of the polyfunctional monomer in the polymerizable monomer is 5 to 100 wt %.

4. A polymer member according to claim 1, wherein:
the polymer member comprises the polymer layer on at least one surface of a base material layer; and
the polymer member has a tensile strength at 23° C. and a rate of pulling of 50 mm/min of 25 N/mm² or more.

5. A polymer member according to claim 4, wherein the base material layer contains at least one kind selected from an inorganic material, an organic material, and a composite of an inorganic material and an organic material.

6. A polymer member according to claim 1, wherein the polymer member comprises the polymer layer on at least one surface of an inorganic base material.

7. A polymer member according to claim 6, wherein the inorganic base material comprises a fibrous inorganic base material.

8. A polymer member according to claim 7, wherein the fibrous inorganic base material comprises a glass cloth.

9. A polymer member according to claim 1, wherein:
the polymer member comprises the polymer layer and a pressure-sensitive adhesion layer; and
the polymer (X) contains the cross-linked polymer and a hydrophilic polymer.

10. A polymer member according to claim 9, wherein, when the pressure-sensitive adhesion layer is attached to glass, left to stand still at room temperature for 24 hours, then immersed in water, and subjected to a peel test in a direction of 90°, 50 mm or more of the pressure-sensitive adhesion layer are peeled from the glass without breakage thereof.

11. A polymer member according to claim 10, wherein a time period for the immersion in water is 3 minutes or more.

12. A cigarette-resistant article, comprising the polymer member according to claim 1 attached to an adherend.

13. A method of providing a resistance to cigarette burns to an adherend, the method comprising attaching the polymer member according to claim 1 to an adherend, thereby providing a resistance to cigarette burns to the adherend.
